(19) United States
(12) Patent Application Publication
(10) Pub. No.: US 2015/0042281 A1
(43) Pub. Date: Feb. 12, 2015

(54) FACILITY FOR STOWING ELECTRONIC DEVICES, AND ELECTRONIC DEVICE SUITABLE FOR THE FACILITY

(71) Applicant: Societe BIC, Clichy Cedex, (FR)

(72) Inventors: Frédéric Marze, La Celle Saint Cloud (FR); Christopher Fauvel, Plaisir (FR)

(21) Appl. No.: 14/388,064

(22) PCT Filed: Mar. 22, 2013
(86) PCT No.: PCT/FR2013/050617

§ 371 Date: Sep. 25, 2014

(30) Foreign Application Priority Data
Apr. 6, 2012 (FR) 12 53231

(51) Int. Cl. H02J 7/00

(52) U.S. Cl. CPC H02J 7/0027; H02J 7/0021; H02J 7/0026
USPC 320/115

(57) ABSTRACT

A cabinet for stowing electronic devices, each of the electronic devices including a rechargeable electric battery enabling the electronic device to be a mobile device. The cabinet includes a power supply adapted to provide electricity, a plurality of housings, each housing being adapted to receive an electronic device and to transfer electricity to the electronic device in order to charge it. The cabinet further includes a control module which detects an inserted state when an electronic device is inserted into a housing of the cabinet, and which orders the turning off or powering of at least one set of components not including the battery of the electronic device if the inserted state is detected, while ensuring that power continues to be supplied to the battery so as to charge it.

### CROSS REFERENCE TO RELATED APPLICATIONS

This application is a national stage application of International Application No. PCT/FR2013/050617, filed on Mar. 22, 2013, which claims the benefit of French Patent Application No. 1253231, filed on Apr. 6, 2012, the entire contents of both applications being incorporated herein by reference.

### BACKGROUND OF THE INVENTION

1. Field of the Invention

The embodiments of the present invention relate to a cabinet (also referred to herein as a “facility”) for stowing electronic devices, and an electronic device intended to be stowed in the cabinet.

More particularly, the invention relates to a cabinet for stowing electronic devices, each of the electronic devices comprising a rechargeable electric battery enabling the electronic device to be a mobile device, and the cabinet including:
a power supply adapted to provide electricity,
a plurality of housings, each housing being adapted to receive an electronic device and to transfer electricity to the electronic device in order to charge it.

2. Description of Related Art

U.S. Pat. No. 6,218,796 describes an example of such a cabinet, where rechargeable electronic devices are stored so that their batteries are recharged while stored there. These rechargeable electronic devices are, for example, laptop computers used for teaching in schools or businesses. Such cabinets can also provide secure storage for electronic devices and allow transporting them from one location to another.

These cabinets consume significant electricity when charging the electronic devices. The recharging must be done as quickly as possible so that the computers can be reused during the next teaching assignment. This type of cabinet tends to heat up considerably during the charging phase. The usual solutions are to provide vents in the cabinet walls and possibly add motorized ventilation.

These vents and ventilation are inadequate.

The embodiments of the present invention aim to improve these cabinets, in particular by providing a solution to the heating problem.

For this purpose, a cabinet according to the invention is characterized in that it further comprises a control module which detects an inserted state when an electronic device is inserted into a housing of the cabinet, and which orders the turning off or powering of at least one set of components not including the battery of the electronic device if the inserted state is detected, while ensuring that power continues to be supplied to the battery so as to charge it.

With these arrangements, the cabinet ensures that the electronic devices inserted into its housings are quickly turned off. In particular, the cabinet can ensure that the electronic devices are not on or in sleep mode.

These electronic devices thus only use electricity to recharge their batteries. The heat released by the supply of power within the cabinet is reduced.

The time required to recharge the electronic devices can thus also be reduced.

In various embodiments of the cabinet according to the invention, one or more of the following arrangements may possibly be used.

In one aspect, the control module immediately orders the turning off of the set of components of the electronic device if the inserted state is detected, by causing the power to be cut off to the set of components within the electronic device without waiting for a software shutdown of the electronic device.

In another aspect, the control module orders the turning off of the set of components of the electronic device if the inserted state is detected, after a predetermined period of between ten seconds and five minutes, by causing the power to be cut off to the set of components within the electronic device without waiting for a software shutdown of the electronic device.

In another aspect, the control module orders a software shutdown of the set of components of the electronic device upon detecting the inserted state, by issuing a shutdown signal.

In another aspect, the control module orders the turning off of the set of components of the electronic device by issuing a cutoff signal.

In another aspect, the control module detects the inserted state when the electric current consumed by the housing reaches a predetermined level, for example greater than 0.5 amps.

In another aspect, the control module detects the inserted state by the presence of a presence signal coming from the electronic device inserted into the housing.

In another aspect, the control module detects the inserted state by a presence detection circuit which comprises at least one element selected from a list comprising: a contact of a housing connector establishing a connection with a corresponding contact of an electronic device connector, an electromagnetic sensor actuated by a magnetic element of the electronic device, and a switch actuated by insertion of the electronic device.

In another aspect, the cabinet further comprises a housing connector that is part of a housing, intended to cooperate with an electronic device connector that is part of the electronic device, the housing connector comprising power supply contacts for transferring electricity to the electronic device connector in order to charge the battery of the electronic device, and at least one contact from among:
a cutoff contact adapted such that the control module emits a cutoff signal on the cutoff contact if the inserted state is detected, the cutoff signal indicating that the cabinet wants to turn off the set of components of the electronic device;
a shutdown contact adapted such that the control module emits a shutdown signal on the shutdown contact if the inserted state is detected, the shutdown signal indicating that the control module wants a software shutdown of the set of components of the electronic device; and
a presence contact adapted such that the control module receives a presence signal from an electronic device, the presence signal indicating that the electronic device is inserted into the housing.

In another aspect, the cabinet further comprises a server computer which has a wireless network connection with the electronic devices at least when they are not inserted into a housing of the cabinet.

In another aspect, the control module comprises:
a processor,
a power switching circuit, controlled by the processor and which can cut the power to one of the housings associated with the power switching circuit, and intended to cut the power to the electronic device inserted into the housing, and
a presence detection circuit connected to the processor in order to inform it of the inserted state of one of the housings when an electronic device is inserted into the housing.

In another aspect, the cabinet comprises outer walls for enclosing within the cabinet the power supply, the control module, the housings, and the electronic devices inserted into the housings, and comprising a door to allow a user to access the housings in order to insert or remove at least one electronic device from one of the housings.

In another aspect, the cabinet comprises wheels to allow a user to move the cabinet.

The invention also relates to an electronic device suitable for stowing in a cabinet provided with a plurality of housings. The electronic device comprises:
a microprocessor, and
a rechargeable electric battery which supplies electricity to a set of components comprising at least the microprocessor, enabling the electronic device to be a mobile device,

characterized in that it further comprises a power control circuit located between the battery and the set of components, the power control circuit detecting an inserted state when the electronic device is inserted into a housing of the cabinet, and turning off the set of components by cutting off its power if the inserted state is detected, while ensuring that power continues to be supplied to the battery so as to recharge the battery.

In various embodiments of the electronic device according to the invention, one or more of the following arrangements may possibly be used.

In one aspect, the power control circuit is adapted to supply power to the set of components when so ordered by the cabinet.

In another aspect, the power control circuit immediately turns off the power to the set of components if the inserted state is detected, without waiting for a software shutdown of the microprocessor.

In another aspect, the power control circuit turns off the power to the set of components if the inserted state is detected, after a predetermined period of between ten seconds and five minutes, without waiting for a software shutdown of the microprocessor.

In another aspect, the power control circuit comprises:
a first input connected to a contact which supplies electricity to the electronic device, a voltage on the first input indicating that the electronic device is inserted into a housing,
a second input receiving a cutoff signal emitted by the cabinet and indicating that the cabinet wants to turn off the power to the set of components, and
control logic which orders a switch to open if the voltage is detected on the first input and if the cutoff signal is detected on the second input, and which orders the switch to close if not.

In another aspect, the electronic device further comprises a presence indicator circuit which sends a presence signal to the cabinet when the electronic device is inserted into a housing of the cabinet.

According to another aspect, the presence indicator circuit is a short-circuit between first and second contacts of an electronic device connector.

In another aspect, the presence indicator circuit comprises an element selected from a list comprising: a contact of an electronic device connector intended to cooperate with a corresponding contact of a housing connector, a magnetic element for actuating an electromagnetic sensor of the cabinet, and a mechanical element for actuating a switch of the cabinet.

In another aspect, the electronic device comprises a touch screen intended to be used by a user when the electronic device is not inserted into a housing of the cabinet, and intended to be turned off and not used by a user when the electronic device is inserted into one of the housings of the cabinet.

In another aspect, the electronic device further comprises a circuit for connecting to a wireless network which receives information from the cabinet, in order to distribute educational information to a user of the electronic device when the electronic device is not inserted into one of the housings of the cabinet.

Other features and advantages of the invention will be apparent from the following description of several of its embodiments, given by way of non-limiting example, with reference to the accompanying drawings.

In the drawings:

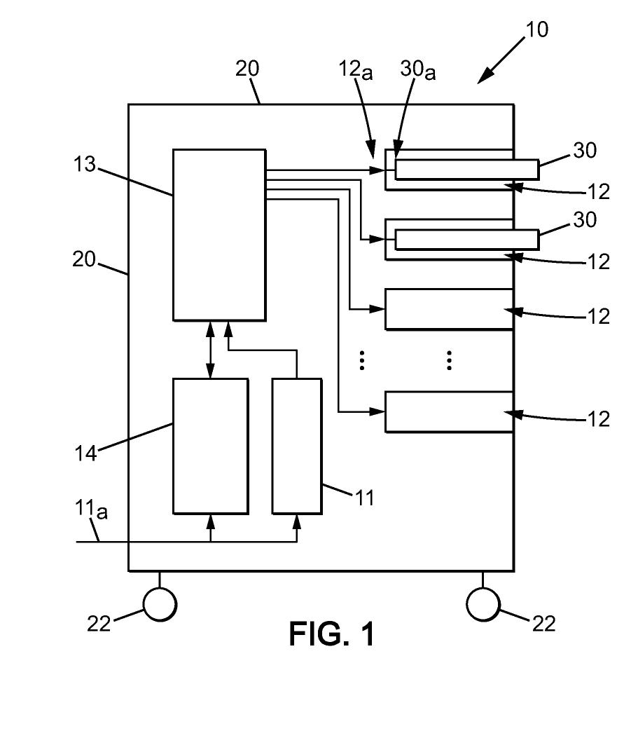

FIG. 1 is a block diagram of a cabinet according to the invention into which rechargeable electronic devices are inserted,

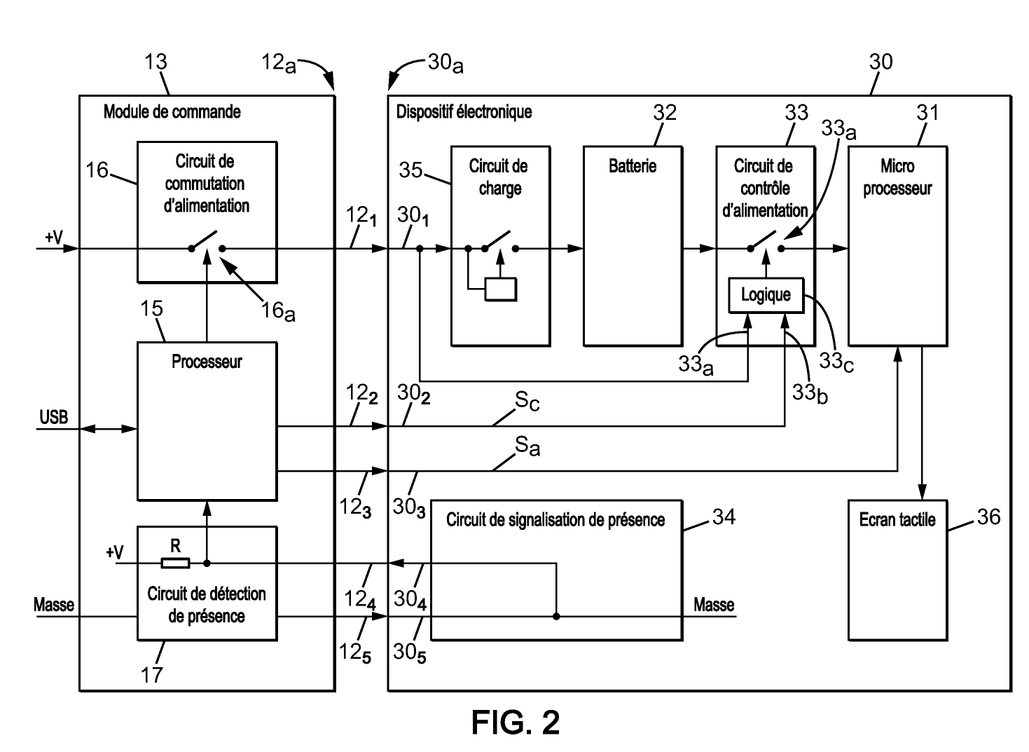

FIG. 2 is a diagram specifically showing the components of the cabinet and of an electronic device of the types shown in FIG. 1,

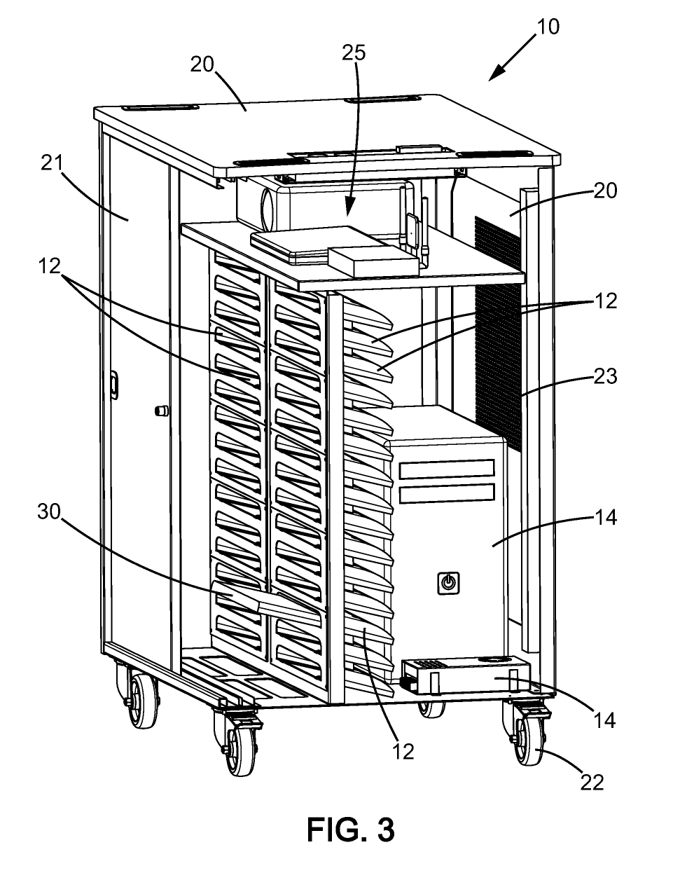

FIG. 3 is a perspective view of a cabinet according to FIG. 1, with a suitable rechargeable electronic device inserted into one of the cabinet housings.

FIG. 1 is a diagram showing a storage cabinet or cart 10, adapted for stowing electronic devices 30 according to the invention.

The electronic devices 30 are, for example, laptop computers, touch-screen tablets, or any mobile electronic devices comprising a microprocessor 31, a screen 36, for example a touch screen, and a rechargeable battery 32 enabling it to be self-sufficient. “Microprocessor” 31 is understood to mean any type of electronic circuit or unit for processing a sequence of instructions for executing a program, such as a processor, a controller or microcontroller, a signal processor (DSP, for “Digital Signal Processing”), etc.

These mobile electronic devices are, for example, intended for use by a student user in a school for educational purposes. The user takes one of the electronic devices, for example when entering the classroom, and puts it back when leaving the classroom. The cabinet handles the recharging of the battery 32 of the electronic devices 30 placed in the cabinet.

The storage cabinet 10 comprises a power supply 11 and a plurality of housings 12.

The power supply 11 is connected to a power grid by a power cord 11a or to a source of stored power such as a battery (not shown). This power supply 11 is adapted to provide electricity to the various components of the cabinet 10.

The housings 12 are spaces within the cabinet adapted to receive the electronic devices 30. Each housing 12 is capable of transferring electricity from the cabinet 10 to an electronic device 30 placed within the housing 12.

The housings 12 and the electronic devices 30 advantageously have a shared mechanical and electrical interface, such that the electronic devices 30 have a shape appropriate for the cabinet housings 12 and vice versa. The housings 12 also comprise a housing connector 12a and the electronic devices 30 comprise a device connector 30a, the housing 12a and device 30a connectors being compatible so as to establish a connection between the contacts of one with the equivalent contacts of the other.

The housing connector 12a comprises a plurality of electrical connection contacts identified by reference numbers 121 to 125. The device connector 30a comprises a plurality of the same number of electrical connection contacts identified by reference numbers 301 to 305.

Each housing 12 allows transferring electricity from the cabinet to the electronic device 30 inserted into one of the housings, for example by the aforementioned connectors.

A housing 12 and an electronic device 30 may possibly have guiding shapes that appropriately position them relative to one other.

The housings 12 are, for example, downwardly inclined toward the rear of the cabinet, meaning in the direction of insertion of the electronic device, as can be seen in FIG. 3. As the connectors 12a, 30a are advantageously also located at the rear of each housing, the weight of the electronic device 30 advantageously exerts force in the direction of the housing connector 12a which establishes a connection between the connectors without any effort by the user.

Additionally, an elastic element comprised in the housing 12 can supplement this force in order to establish a connection between the connectors even more effectively, meaning to ensure a sufficiently reliable electrical connection for transferring electricity from the cabinet to the electronic device.

The cabinet 10 can thus transfer electricity to each electronic device 30 so as to recharge the internal battery or batteries 32 of the electronic device.

The cabinet 10 of the invention further comprises a control module 13 that detects an inserted state when an electronic device 30 is inserted into one of the housings 12. This control module 13 then orders at least a portion or the entire set of components of the electronic device to turn off if the inserted state of the housing is detected. However, the supply of electricity to the battery 32 of the electronic device 30 is maintained within the electronic device, and the battery 32 is recharged.

The portion or set of components of the electronic device 30 which is turned off comprises at least the microprocessor 31, and preferably also the screen 36. In particular, this set of components does not include the battery 32 of the electronic device 30. Thus, if an electronic device 30 is inserted into a cabinet housing 12 when still on, the control module 13 of the cabinet can order the set of components or circuits to turn off, without requiring any user intervention. The electronic device 30 thus uses less electricity than if it had not been ordered to power down. The cabinet power supply 11 therefore supplies less electricity and does not heat up as much.

The control module 13 is supplied electricity by the line 13a from the power supply 11, and distributes the electricity through lines 13c to each housing 12 of the cabinet 10 (meaning to the housing connector 12a) to allow transferring electricity to each electronic device 30 inserted into the housing 12.

The cabinet 10 further comprises, for example, a server computer 14 that distributes educational information to each of the electronic devices 30 over a wireless network connection when the electronic device 30 is not inserted into the cabinet 10 (removed by the user) and is turned on.

The server computer 14 may be connected to the control device 13 by a connection 13b such as a USB (Universal Serial Bus) connection. The server computer can thus control the control module or retrieve information from it. For example, it can order the turning off or powering (waking up) of each electronic device 30 or of a predetermined selection of electronic devices 30. After turning on or waking up the device(s), the controller 13 can download data to each electronic device. It can update software internal to each electronic device. It can identify the electronic devices inserted into the cabinet 30, count them, check their charge status.

In a first variant, the control module 13 immediately orders the turning off of all components of the electronic device 30, without waiting for any software shutdown of the electronic device 30. Such a forced shutdown is possible because no information about the student user or his or her work or the education being provided is permanently stored in the electronic device 30.

The electronic devices 30 are shared by multiple students in multiple classes and the student does not care which electronic device 30 he or she picks up when entering the classroom.

The presence of voltage on the housing connector 12a is sufficient for example to cause the set of components of the electronic device to be turned off immediately: the electronic device 30 detects the presence of this voltage at its connector and cuts the power to the internal set of components, for example turning off its microprocessor 31 and screen 36.

In a second variant, the control module 13 orders the turning off of the set of components of the electronic device 30 if the inserted state is detected after a predetermined time, for example between ten seconds and five minutes.

The electronic device 30 thus has enough time for example to perform its own software shutdown, meaning it can turn off the set of components of the electronic device 30 after all processes and tasks have ended.

For example, and although it is preferred that the work of each student is saved in real time on the server computer 14, it may be helpful to finalize the transmission of information concerning the student's work to the server computer 14.

In this second variant, the electronic device 30 itself detects the inserted state in order to execute a software shutdown.

In a third variant, the control module 13 orders a software shutdown of the electronic device 30 as soon as the inserted state is detected. For example, the control unit 13 issues a shutdown signal Sa on a contact 123 of the housing connector 12a of the housing 12 where the control module 13 has detected a new insertion of an electronic device 30 and for which it wants to initiate a software shutdown.

If the software shutdown does not complete, the provisions of the second variant can be implemented. In effect, if the software shutdown does not work, the control module 13 can order the turning off of the set of components of the electronic device 30 if the inserted state is detected, after a predetermined period. This predetermined period is greater than the period normally required for the electronic device 30 to perform a software shutdown. For example, the control module 13 emits a cutoff signal Sc on a contact 122 of the housing connector 12a of the housing 12 where the control module 13 has detected a new insertion of an electronic device 30 and for which a powering off has not occurred within the predetermined period and for which it wants a shutdown to occur.

Many means may be implemented by the control module 13 for detecting the insertion of an electronic device 30 in a housing 12.

In a first detection variant, the electronic module 13 comprises a current sensor on each line 13c distributing electricity to each housing. If there is no electronic device in the housing, the sensor measures a consumed electric current of zero. When an electronic device 30 is inserted into the housing 12, it consumes at least the electricity required to check the charge level in its battery 32, and possibly to charge the battery 32. The sensor measures the level of current consumed. The control module 13 can thus consider that an electronic device 30 has been inserted into a housing 12 if the consumption of electrical current reaches or exceeds a predetermined level, the predetermined level being for example greater than 0.5 amps.

In a second detection variant, the electronic module 13 detects the inserted state if it receives a presence signal Sp from an electronic device 30.

This presence signal Sp may, for example, be emitted by the electronic device 30 on a contact 304 of its device connector 30a and received on a corresponding contact 124 of the housing connector 12a. Such a variant is represented in FIG. 2, which shows a possible embodiment of the control module 13 and electronic device 30 together.

The cabinet 10 further comprises outer walls 20 which enclose its various elements: power supply 11, housings 12, control module 13, and server computer 14. It further comprises at least one specific wall in the form of a door 21 to allow a user to access the housings 12 and to insert or remove an electronic device 30. The cabinet 10 therefore encloses the electronic devices 30 within a small space. The door 21 may be provided with a lock to control access to the electronic devices 30 and protect them from theft during periods of prolonged storage where the cabinet and electronic devices are not in use.

These walls 20 enclose the elements of the cabinet. All elements of the cabinet consume electricity, which produces heat that heats up the cabinet. The walls 20 of the cabinet are therefore provided with openings 23, as is known, to allow heat to escape to the outside.

The control module 13 of the invention powers down the electronic devices 30 in order to limit and reduce the consumption of electricity in the cabinet, and to limit and reduce the production of heat in the cabinet.

The cabinet 10 may also advantageously be equipped with wheels 22 for moving it about, for example from one classroom to another. The cabinet 10 is therefore small in size and occupies little space. For example, the cabinet measures less than 1 m in each direction. This cabinet 10 also has limited weight, so it is easy to move. For example, the cabinet 10 weighs less than 50 kg. The structural elements of the cabinet such as its walls, doors, and housings, are therefore advantageously constructed to minimize their weight. They are made, for example, of sheet steel, sheet aluminum, or plastic.

It comprises, for example, a server computer 14 and thirty housings 12 for charging electronic devices 30. If each electronic device 30 consumes 20 watts when recharging, all the electronic devices consume 600 watts when recharging. Together, all the elements of the cabinet 10 may then consume up to 1 kWatt. The cabinet 10 therefore heats up.

An embodiment will now be described with respect to FIG. 2 which represents a control module 13 and an electronic device 30 connected to this module.

In this embodiment, the control module 13 comprises:
a processor 15 to be connected to the server computer 14, for example by a network connection or a USB connection 13b,
a power switching circuit 16 controlled by the processor 15, and
a presence detection circuit 17 connected to the processor 15 in order to inform it of an inserted state of a housing 12, when an electronic device 30 is inserted into the housing.

“Processor” 15 is understood to mean any type of electronic circuit or unit for processing a sequence of instructions for executing a program, such as a microprocessor, a controller or microcontroller, a signal processor (DSP, for “Digital Signal Processing”), etc.

The switching circuit 16 comprises, for example, an input connected to the power supply 11 of the cabinet 10. This power supply is for example a 12-volt DC voltage V+, suitable for charging an electronic device 30.

The switching circuit 16 comprises an output connected to a housing 12. This output is adapted for supplying a voltage +V to the housing 12 and thus for supplying electricity to an electronic device 30 inserted into the housing 12.

The switching circuit 16 comprises a switch 16a controlled by the processor 15.

The control module 13 comprises as many switching circuits 16 as there are housings 12 in the cabinet 10, with the processor 15 controlling the opening and closing of each switching circuit.

The processor 15 can thus cut off or supply electricity to each housing 12.

This allows cutting off electricity to a housing 12 associated with the power switching circuit 16 in order to cut off all power to the electronic device 30: the battery 32 and all components of the electronic device (microprocessor 31 and screen 36).

With such switching circuits 16, the processor 15 can also cut off the electricity to a first group of housings 12 while supplying electricity to a second group of housings 12. This reduces the consumption of electricity and the heat released.

It can supply power to the first group at a different time than to the second group, and thereby distribute over time the supply of electricity to the housings 12 of the cabinet 10. This reduces the power consumption and the heat released at a given moment.

With these arrangements, the control module 13 is able to optimize the supply of power to the housings 12 of the cabinet and therefore the charging of the batteries of the electronic devices 30 stowed in the housings 12, while reducing the heat released in the cabinet.

The presence detection circuit 17 is connected to the processor 15 and provides it with inserted state information for a housing 12.

In the embodiment shown, the presence detection circuit 17 comprises a resistor R known as a pull-up resistor. It is connected at its first end to the voltage V+. It is connected at its second end to a contact 124 of the housing connector in order to receive a presence signal Sp from the electronic device, and to an input of the processor 15. In the present case, the presence signal Sp is caused by the electronic device 30 grounding the contact 124. The electronic device 30 adapted for this presence detection circuit 17 comprises only a short-circuit to ground of a contact 304 of the device connector 30a in correspondence with the contact 124 of the housing connector 12a connected to the second end of the resistor R. In such a circuit, the input of the processor 15 receives a voltage at +V when the electronic device 30 is not inserted (when the contact 124 is exposed). It receives a ground potential (zero) otherwise.

Other types of presence detection circuit 17 are possible.

In particular, a magnetic sensor can be used, with the electronic device 30 comprising a magnetic element 30 that faces the sensor when the electronic device 30 is inserted into a housing.

The presence detection circuit 17 may be a switch actuated mechanically by the insertion of an electronic device 30 into a housing 12.

The control module 13 comprises as many presence detection circuits 17 as there are housings 12 in the cabinet 10, in order to detect the insertion of an electronic device 30 for each of the housings 12.

The electronic device 30 is powered by the following circuits.

A contact 301 of the device connector 30a receives the supply voltage +V from the power switching circuit 16. This contact 301 is connected to a charging circuit 35. The charging circuit 35 controls the voltage and/or current that is sent to the battery 32, in order to optimize charging.

The charging circuit 35 is connected to the battery 32 (or set of batteries) which stores electrical energy for powering the electronic device 30 when the device needs to be self-sufficient: when it is turned on and not placed in the cabinet 10.

The battery 32 is connected to a power control circuit 33, which comprises:
a first input 33a connected to the contact 301 of the device connector, the contact receiving the supply of electricity, a voltage on the first input 33a indicating that the electronic device is inserted into a housing 12,
a second input 33b connected to a contact 302 which receives a cutoff signal Sc emitted by the processor 15 indicating that the cabinet 10 wants to cut off power to the microprocessor 31 of the electronic device (set of components of the electronic device), and
control logic 33c which orders a switch 33d to open if the voltage is detected on the first input 33a and if the cutoff signal Sc is detected on the second input 33b, and which orders the switch 33d to close if not.

The power control circuit 33 thus controls the supply of electricity to the circuits powered by its output.

In particular, the power control circuit 33 is connected to the microprocessor 31 of the electronic device 30. It is also connected to a set of circuits: a memory, a display 36, and any type of conventional circuit.

The cutoff signal Sc also allows restoring power or waking up the set of components that includes the microprocessor 31, when so ordered by the control module 13.

The cutoff signal Sc is preferably in the low state (zero volts or less than 1 volt for example) when ordering that power be cut off to the set of components. Thus, the control logic 33c opens the switch 33d if the voltage is present on the first input 33a and if the cutoff signal Sc on the second input 33b is in the low state. This way, if the low state is the default, the power control circuit 33 cuts off the power by default when the electronic device 30 is inserted into the slot.

Conversely, the cutoff signal Sc is in the high state (greater than 5 Volts for example) when the control module 13 has ordered that power be supplied to the set of components including the microprocessor 31. This supply of power allows turning on each electronic device stowed in the cabinet 10. The computer server 14 can then begin communicating with the electronic device by any means, for example wirelessly via WiFi. The server computer 14 can then download software or information (lessons), or download a new version of software internal to the electronic device 30 in order to update the software. The server computer 14 is therefore able to perform maintenance for the electronic devices 30, all at the same time or in batches. The computer server 14 stores the configuration of each electronic device 30 and knows which electronic device is stowed in a housing 12. It therefore knows which electronic devices are not in use, and can predetermine a selection of electronic devices 30 to which software changes are to be applied, and can do this autonomously. In particular, software updates can easily be applied during predetermined time periods.

The electronic device 30 of the invention preferably comprises a touch screen 36 to allow the student user to respond to exercises downloaded by the server computer 14 into the memory of the electronic device.

The electronic device 30 further comprises a contact 303 connected directly or indirectly to an input of the microprocessor 31 in order to transmit a shutdown signal Sa from the processor 15 of the control module 13. With this shutdown signal, the control module 13 can request a software shutdown of the microprocessor 31 and the associated circuits (memory, display). The microprocessor 31 executes for example a program that periodically examines the input to the microprocessor to determine whether a software shutdown is required.

It is also possible for the input to the microprocessor 15 to be used for a software startup and shutdown function controlled by an on/off button of the electronic device 30. In this case, the logic will appropriately combine the signals from this button with the shutdown signal Sa, for example using a logical AND function.

FIG. 3 is a perspective view of one embodiment of a cabinet 10 where a wall and a door have been eliminated to provide a view inside the cabinet 10. An electronic device 30 is inserted in one of the housings 12. The housings 12 face the doors 21. The server computer 14 and the power supply 11 are located behind the housings 12. A top shelf 24 supports other elements 25 such as a wireless router, a laptop computer for the teacher, and a video projector.

1-22. (canceled)

23. A cabinet for stowing electronic devices, each of the electronic devices comprising a rechargeable electric battery enabling the electronic device to be a mobile device, and the cabinet comprising:
a power supply adapted to provide electricity;
a plurality of housings, each housing being adapted to receive an electronic device and to transfer electricity to the electronic device in order to charge it; and
a control module which detects an inserted state when an electronic device is inserted into a housing of the cabinet, and which orders the turning off or powering of at least one set of components not including the battery of the electronic device if the inserted state is detected, while ensuring that power continues to be supplied to the battery so as to charge it.

24. The cabinet according to claim 23, wherein the control module immediately orders the turning off of the set of components of the electronic device if the inserted state is detected, by causing the power to be cut off to the set of components within the electronic device without waiting for a software shutdown of the electronic device.

25. The cabinet according to claim 23, wherein the control module orders the turning off of the set of components of the electronic device if the inserted state is detected, after a predetermined period of between ten seconds and five minutes, by causing the power to be cut off to the set of components within the electronic device without waiting for a software shutdown of the electronic device.

26. The cabinet according to claim 23, wherein the control module orders a software shutdown of the set of components of the electronic device upon detecting the inserted state, by issuing a shutdown signal.

27. The cabinet according to claim 23, wherein the control module orders the turning off of the set of components of the electronic device by issuing a cutoff signal.

28. The cabinet according to claim 23, wherein the control module detects the inserted state when the electric current consumed by the housing reaches a predetermined level, for example greater than 0.5 amps.

29. The cabinet according to claim 23, wherein the control module detects the inserted state by a signal coming from the electronic device inserted into the housing.

30. The cabinet according to claim 23, wherein the control module detects the inserted state by a detection circuit which comprises at least one element selected from a list comprising a contact of a housing connector establishing a connection with a corresponding contact of an electronic device connector, an electromagnetic sensor actuated by a magnetic element of the electronic device, and a switch actuated by insertion of the electronic device.

31. The cabinet according to claim 23, further comprising a housing connector that is part of a housing, intended to cooperate with an electronic device connector that is part of the electronic device, the housing connector comprising power supply contacts for transferring electricity to the electronic device connector in order to charge the battery of the electronic device, and at least one contact from among:
a cutoff contact adapted such that the control module emits a cutoff signal on the cutoff contact if the inserted state is detected, the cutoff signal indicating that the cabinet wants to turn off the set of components of the electronic device;
a shutdown contact adapted such that the control module emits a shutdown signal on the shutdown contact if the inserted state is detected, the shutdown signal indicating that the control module wants a software shutdown of the set of components of the electronic device; and
a contact adapted such that the control module receives a signal from an electronic device, the signal indicating that the electronic device is inserted into the housing.

32. The cabinet according to claim 23, further comprising a server computer which has a wireless network connection with the electronic devices at least when they are not inserted into a housing of the cabinet.

33. The cabinet according to claim 23, wherein the control module comprises:
a processor,
a power switching circuit, controlled by the processor and which can cut the power to one of the housings associated with the power switching circuit, and intended to cut the power to the electronic device inserted into the housing, and
a detection circuit connected to the processor in order to inform it of the inserted state of one of the housings when an electronic device is inserted into the housing.

34. The cabinet according to claim 23, comprising outer walls for enclosing within the cabinet the power supply, the control module, the housings, and the electronic devices inserted into the housings, and comprising a door to allow a user to access the housings in order to insert or remove at least one electronic device into or from one of the housings.

35. The cabinet according to claim 23, comprising wheels to allow a user to move the cabinet.

36. An electronic device suitable for stowing in a cabinet provided with a plurality of housings, the electronic device comprising:
a microprocessor, and
a rechargeable electric battery which supplies electricity to a set of components comprising at least the microprocessor, enabling the electronic device to be a mobile device, and
a power control circuit located between the battery and the set of components, the power control circuit detecting an inserted state when the electronic device is inserted into a housing of the cabinet, and turning off the set of components by cutting off its power if the inserted state is detected, while ensuring that power continues to be supplied to the battery so as to recharge the battery.

37. The electronic device according to claim 36, wherein the power control circuit is adapted to supply power to the set of components when so ordered by the cabinet.

38. The electronic device according to claim 36, wherein the power control circuit immediately turns off the power to the set of components if the inserted state is detected, without waiting for a software shutdown of the microprocessor.

39. The electronic device according to claim 37, wherein the power control circuit turns off the power to the set of components if the inserted state is detected, after a predetermined period of between ten seconds and five minutes, without waiting for a software shutdown of the microprocessor.

40. The electronic device according to claim 36, wherein the power control circuit comprises:
a first input connected to a contact which supplies electricity to the electronic device, a voltage on the first input indicating that the electronic device is inserted into a housing,
a second input receiving a cutoff signal emitted by the cabinet and indicating that the cabinet wants to turn off the power to the set of components, and
control logic which orders a switch to open if the voltage is detected on the first input and if the cutoff signal is detected on the second input, and which orders the switch to close if not.

41. The electronic device according to claim 36, further comprising an indicator circuit which sends a signal to the cabinet when the electronic device is inserted into a housing of the cabinet.

42. The electronic device according to claim 41, wherein the indicator circuit is a short-circuit between first and second contacts of an electronic device connector.

43. The electronic device according to claim 41, wherein the indicator circuit comprises an element selected from a list comprising a contact of an electronic device connector intended to cooperate with a corresponding contact of a housing connector, a magnetic element for actuating an electromagnetic sensor of the cabinet, and a mechanical element for actuating a switch of the cabinet.

44. The electronic device according to claim 36, comprising a touch screen intended to be used by a user when the electronic device is not inserted into a housing of the cabinet, and intended to be turned off and not used by a user when the electronic device is inserted into one of the housings of the cabinet.

45. The electronic device according to claim 36, further comprising a circuit for connecting to a wireless network which receives information from the cabinet, in order to distribute educational information to a user of the electronic device when the electronic device is not inserted into one of the housings of the cabinet.
